(19) United States
(12) Patent Application Publication
(10) Pub. No.: US 2026/0296173 A1
(43) Pub. Date: Oct. 1, 2026

(54) INTEGRATED WET BRAKE MOUNT

(71) Applicant: Schaeffler Technologies AG & Co. KG, Herzogenaurach (DE)

(72) Inventor: Nicholas Wurst, Wadsworth, OH (US)

(21) Appl. No.: 19/092,367

(22) Filed: Mar. 27, 2025

(51) Int. Cl. B60K 5/12; B60T 1/06

(52) U.S. Cl. CPC B60K 5/1216; B60T 1/062

(57) ABSTRACT

A mounting system may include one or more mounting structures. The mounting structures may include one or more arms, wherein each of the one or more arms radiate from a common body. The mounting structures may include one or more flanges, wherein each of the one or more flanges are integrated into one of the one or more arms, each flange including one or more wet brake mounts. The mounting structures may include one or more drive unit mounts, wherein each of the one or more arms includes one of the one or more drive unit mounts, wherein each of the one or more drive unit mounts are located on a distal end of a corresponding one or more arms. The mounting structures may include one or more chassis mounts, wherein the one or more chassis mounts are located on the common body.

### TECHNICAL FIELD

The present disclosure generally relates to vehicle brakes, and, more particularly, to wet brakes.

### BACKGROUND

Wet brakes are constantly cooled by oil, as they are in an environment in which they are constantly surrounded by oil. This may be advantageous for the brakes, as the brakes may be protected from dirt and water, as well as being constantly lubricated and cooled. This may allow wet brakes to last significantly longer than other brakes, even to the point where the wet brakes last the life of the vehicle. However, wet brakes generally need to be installed on vehicles during their manufacture, as it is difficult to retrofit wet brakes to an existing vehicle. Therefore, it would be advantageous to provide a device, system, and method that cures the shortcomings described above.

### SUMMARY

A mounting system is disclosed, in accordance with one or more embodiments of the present disclosure. The mounting system may include one or more mounting structures. The one or more mounting structures may include one or more arms, wherein each of the one or more arms radiate from a common body. The one or more mounting structures may include one or more flanges, wherein each of the one or more flanges are integrated into one of the one or more arms, wherein each of the one or more flanges includes one or more wet brake mounts. The one or more mounting structures may include one or more drive unit mounts, wherein each of the one or more arms includes one of the one or more drive unit mounts, wherein each of the one or more drive unit mounts are located on a distal end of a corresponding one or more arms. The one or more mounting structures may include one or more chassis mounts, wherein the one or more chassis mounts are located on the common body.

In some aspects, the one or more mounting structures are configured as two separate mounting structures.

In some aspects, the mounting system further includes a bent end, wherein the bent end extends from the one or more flanges, wherein the one or more flanges is disposed between the common body and the bent ends.

In some aspects, the two separate mounting structures are not mirror images of each other.

In some aspects, the one or more mounting structures are configured as a single, integrated mounting structure.

In some aspects, at least one of the one or more drive unit mounts is countersunk or counterbored into the corresponding arm.

In some aspects, the one or more chassis mounts are blind holes.

In some aspects, the one or more drive unit mounts and the one or more wet brake mounts are through holes.

In some aspects, the one or more arms include a bent end located on the distal end of the one or more arms, wherein the bent end includes one of the one or more drive unit mounts.

In some aspects, the one or more mounting structures further include one or more pass throughs, wherein the one or more pass throughs are configured to provide access to the at least one of the one or more wet brake mounts or at least one of the one or more drive unit mounts.

A wet brake assembly is disclosed, in accordance with one or more embodiments of the present disclosure. The wet brake assembly may include a mounting system. The mounting system may include one or more mounting structures. The one or more mounting structures may include one or more arms, wherein each of the one or more arms radiate from a common body. The one or more mounting structures may include one or more flanges, wherein each of the one or more flanges are integrated into one of the one or more arms, wherein each of the one or more flanges includes one or more wet brake mounts. The one or more mounting structures may include one or more drive unit mounts, wherein each of the one or more arms includes one of the one or more drive unit mounts, wherein each of the one or more drive unit mounts are located on a distal end of a corresponding one or more arms. The one or more mounting structures may include one or more chassis mounts, wherein the one or more chassis mounts are located on the common body. The wet brake assembly make include a wet brake. The wet brake may include one or more wet brake flanges, wherein the wet brake flanges include one or more wet brake flange mounts, wherein the one or more flanges of the mounting system and the one or more wet brake flanges of the wet brake are aligned such that the mounting system and the wet brake are coupled by the one or more wet brake mounts and the one or more wet brake flange mounts.

In some aspects, the one or more wet brake flange mounts are through holes.

In some aspects, the one or more wet brake flange mounts are spaced about the one or more wet brake flanges such that at least one of the one or more wet brake flange mounts aligns with at least one of the one or more wet brake mounts.

In some aspects, the one or more wet brake flanges is configured as a single wet brake flange that encircles the wet brake.

A drive assembly is disclosed, in accordance with one or more embodiments of the present disclosure. The drive assembly may include a mounting system. The mounting system may include one or more mounting structures. The one or more mounting structures may include one or more arms, wherein each of the one or more arms radiate from a common body. The one or more mounting structures may include one or more flanges, wherein each of the one or more flanges are integrated into one of the one or more arms, wherein each of the one or more flanges includes one or more wet brake mounts. The one or more mounting structures may include one or more drive unit mounts, wherein each of the one or more arms includes one of the one or more drive unit mounts, wherein each of the one or more drive unit mounts are located on a distal end of a corresponding one or more arms. The one or more mounting structures may include one or more chassis mounts, wherein the one or more chassis mounts are located on the common body. The drive assembly make include a wet brake. The wet brake may include one or more wet brake flanges, wherein the wet brake flanges include one or more wet brake flange mounts, wherein the one or more flanges of the mounting system and the one or more wet brake flanges of the wet brake are aligned such that the mounting system and the wet brake are coupled by the one or more wet brake mounts and the one or more wet brake flange mounts. The drive assembly may include a drive unit, wherein the mounting system is coupled to the drive unit by the one or more drive unit mounts, wherein a torque generated by the wet brake is directed to the one or more chassis mounts and away from the one or more drive unit mounts.

In some aspects, the drive unit is an electric vehicle drive unit.

In some aspects, the drive unit includes an output on either side of the drive unit.

In some aspects, the wet brake is located at an output on one side of the drive unit with the mounting system.

In some aspects, the wet brake is located at an output on both sides of the drive unit with the mounting system.

In some aspects, a position and an orientation of the one or more drive unit mounts is based on corresponding mounting locations to which the one or more drive unit mounts couple to the drive unit.

### BRIEF DESCRIPTION OF THE DRAWINGS

The numerous advantages of the disclosure may be better understood by those skilled in the art by reference to the accompanying figures.

FIG. 1A depicts a front view of a mounting system, in accordance with one or more embodiments of the present disclosure.

FIG. 1B depicts an isometric view of a mounting system, in accordance with one or more embodiments of the present disclosure.

FIG. 1C depicts an isometric view of a mounting system, in accordance with one or more embodiments of the present disclosure.

FIG. 2A depicts a front view of a wet brake assembly, in accordance with one or more embodiments of the present disclosure.

FIG. 2B depicts an isometric view of a wet brake assembly, in accordance with one or more embodiments of the present disclosure.

FIG. 2C depicts a front view of a wet brake, in accordance with one or more embodiments of the present disclosure.

FIG. 2D depicts a cross-sectional view of a wet brake, in accordance with one or more embodiments of the present disclosure.

FIG. 3A depicts a front view of a drive assembly, in accordance with one or more embodiments of the present disclosure.

FIG. 3B depicts a side view of a drive assembly, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a mounting system for wet brakes. Wet brakes may have many advantages over typical brakes, such as longer lifespan and higher efficiency. Therefore, it may be beneficial to include these brakes on commercially produced vehicles. However, wet brakes may be difficult to install after production, leading to a need for a way to retrofit vehicles for wet brakes. The mounting system described herein may support wet brakes on a vehicle and also couple to a drive unit of a vehicle, allowing for easier retrofitting of wet brakes and for modularity in its design.

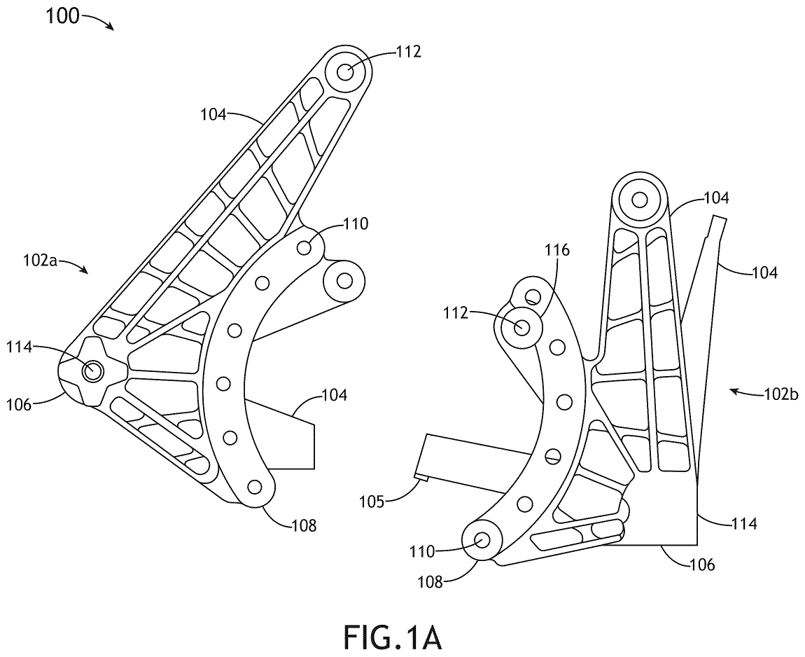

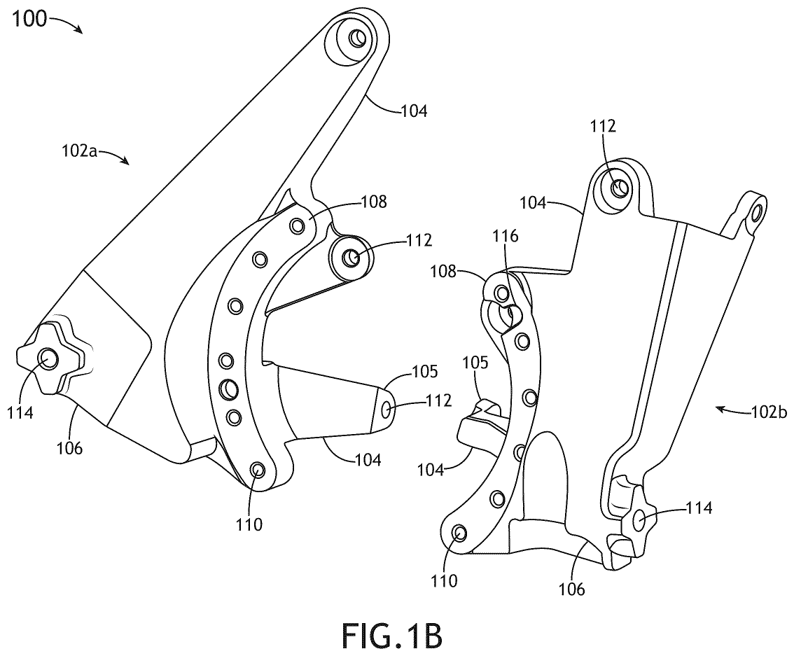

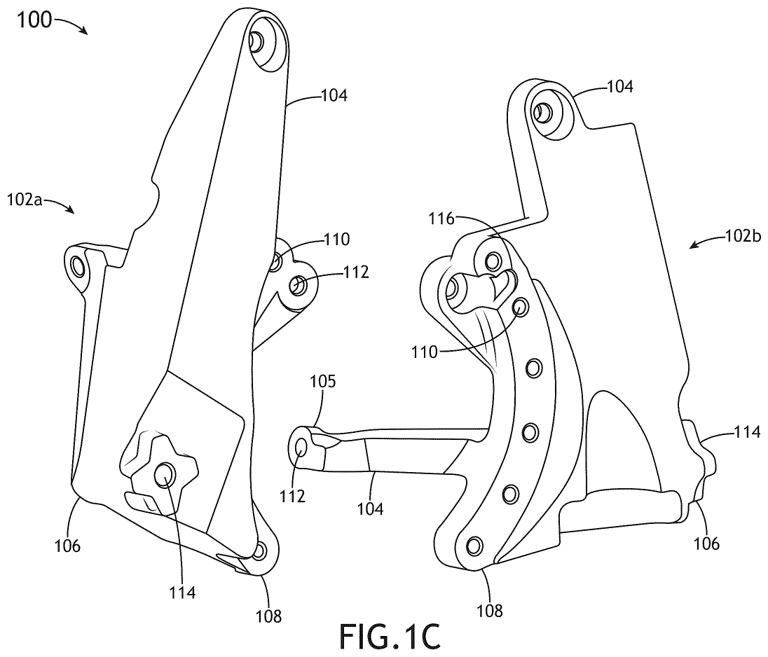

FIGS. 1A-1C depict a mounting system 100, in accordance with one or more embodiments of the present disclosure.

In embodiments, the mounting system 100 includes one or more mounting structures 102. The mounting structures 102 may be any body designed to couple a wet brake to a vehicle. The mounting structures 102 may be made from a single piece of material, or may be made from several pieces of material that are coupled to each other. For example, the mounting structures 102 may include one or more components welded or otherwise fused together (e.g., bolted, screwed, riveted, or the like).

The mounting structures 102, or any components of the mounting structures 102, may be made from any material or combination of materials known in the art. For example, materials such as steel, stainless steel, iron, magnesium, aluminum, titanium, alloys, or the like may be used to form the mounting structures 102.

The mounting system 100 may also include a mounting structure 102 configured as a single, integrated mounting structure 102.

It is contemplated that the mounting structures 102 may be configured as two mounting structures 102 (e.g., a first mounting structure 102a and a second mounting structure 102b). For example, two mounting structures 102 may be used to reduce weight of the mounting system 100. The weight may be reduced due to the lack of connections that would be required when constructing a single mounting structure 102. Additionally, separate mounting structures 102 may provide easier manufacturing.

In embodiments where two mounting structures 102 are used, the two mounting structures 102 may be mirror images of each other (e.g., the first mounting structure 102a may be a mirror image of the second mounting structure 102b). However, as shown in FIGS. 1A-1C, it is also noted that in embodiments where two mounting structures 102 are used, the two mounting structures 102 may not be mirror images of each other (e.g., the first mounting structure 102a may not be a mirror image of the second mounting structure 102b). Instead, the first mounting structure 102a and the second mounting structure 102b may include different positions, orientations, sizes, and/or numbers of the arms 104, bent ends 105, common body 106, flanges 108, wet brake mounts 110, drive unit mounts 112, chassis mounts 114, and/or pass throughs 116.

It is further contemplated that more than two mounting structures 102 may be used. Such a configuration may be helpful to accommodate difficult to access mounting points, difficult part geometries, or the like.

The mounting structures 102 may be manufactured in any manner known in the art. For example, the mounting structures 102 may be cast. By way of another example, the mounting structures 102 may be machined (e.g., machined from a single piece of material).

In embodiments, the mounting structures 102 include one or more arms 104. The arms 104 may be any shape. For example, the arms 104 may be shaped like curved triangles (e.g., as shown in FIGS. 1A-1C). It is noted that the curved profile of the arms 104 may be beneficial to reduce unnecessary stress in the mounting system 100.

The arms 104 may be in contact with each other. In this way, a portion of one arm 104 may be coupled to, and extend partway along, a portion of another arm 104. Such a configuration may provide additional strength for the mounting system 100. However, this example should be interpreted as nonlimiting, as the arms 104 may have any degree of contact with one another.

The arms 104 may be made from a solid piece of material. Additionally, as shown in FIG. 1A, each of the arms may include ribbing. This ribbing may be a series of raised structures on the arms 104 that provide additional strength to the mounting structures 102 without adding unnecessary weight to the mounting structures 102.

One or more arms 104 of the mounting structure 102 may further include a bent end 105. The bent end 105 may be a piece of material that is bent away from the rest of the arm 104. For example, the bent end 105 may be bent 90 degrees (or approximately 90 degrees) away from the arm 104. However, the bent end 105 may also be bent at an acute angle or an obtuse angle relative to the arm 104. The angle at which the bent end 105 is bent may depend on geometry of features in the vehicle to which the mounting system 100 will mount a wet brake.

Further, each bent end 105 may be located at a distal end of the arms 104. It is noted that while all arms 104 may include a bent end, only some arms 104, or none of the arms 104, may include a bent end 105.

In embodiments, the mounting structures 102 include a common body 106. The common body 106 may be a bulk of material. The arms 104 may each extend (e.g., radiate) out of the common body 106. It is noted that the term “common” may refer to the fact that each of the arms 104 of the respective mounting structures 102 may extend from a respective one of the common bodies 106 (e.g., the arms 104 of the first mounting structure 102a may extend from the common body 106 of the first mounting structure 102a, the arms 104 of the second mounting structure 102b may extend from the common body 106 of the second mounting structure 102b). Notably, the mounting structures 102 may each include separate of the common bodies 106. It is contemplated that the arms 104 may extend out of the common body 106 at any angle. For example, arms 104 may extend out of the common body 106 in a manner perpendicular to another arm. By way of another example, arms may extend out of the common body 106 in a manner parallel to another arm. However, these examples are intended to be exemplary rather than limiting, and any angular relationship may be present between one arm 104 and another arm 104.

In embodiments, the mounting structures 102 include one or more flanges 108. The flanges 108 may be built (e.g., machined) into the mounting structures 102 or may be made from a separate material and coupled to the mounting structures 102. The bent ends 105 may extend from the flanges 108. The flanges 108 may be disposed between the common body 106 and the bent ends 105.

The flanges 108 may or may not be continuous. For example, the mounting structures 102 may include one or more flanges 108. Therefore, the flange 108 may be a closed shape (e.g., a circle) or one or more flanges 108 may be spaced about the mounting structures 102 to form a segmented shape (e.g., as shown in FIGS. 1A-1C).

The flanges 108 may be curved. For example, the flanges 108 may be shaped as circular sections or as a circle. However, the flanges 108 may also be curved but not have the geometry of circular sections or as a circle (e.g., an oval or oval sections). It is noted that the flanges 108 may be any shape such that they can be coupled to a desired object, such as, but not limited to, a wet brake.

In embodiments, the one or more flanges 108 include one or more wet brake mounts 110. For example, the wet brake mounts 110 may be spaced about the flange 108. The wet brake mounts 110 may be spaced evenly about the flange 108 or at uneven intervals on the flange. It is contemplated that the wet brake mounts 110 may be through holes in order to receive a bolt, a screw, or the like. Further, the wet brake mounts 110 may be threaded.

In embodiments, the mounting structures 102 include one or more drive unit mounts 112. For example, the drive unit mounts 112 may be located on the arms 104. The drive unit mounts 112 may be located on the distal ends of the arms 104 (e.g., the ends of the arms away from the common body 106). Additionally, any number of the arms 104 may include a drive unit mount 112. For example, each arm 104 may include a drive unit mount 112. However, each arm 104 may not require a drive unit mount 112, and fewer arms 104 may include a drive unit mount 112.

For example, the drive unit mounts 112 may be countersunk into the arm 104. By way of another example, the drive unit mounts 112 may be counterbored into the arm 104. By way of another example, the drive unit mounts 112 may not be countersunk or counterbored into the arm 104. It should be noted that any of the drive unit mounts 112 may be countersunk or counterbored, while any other of the drive unit mounts 112 may not be countersunk or counterbored. It is contemplated that the drive unit mounts 112 may be through holes in order to receive a bolt, a screw, or the like. Further, the drive unit mounts 112 may be threaded.

Additionally, in embodiments including bent ends 105 on the arms 104 of the mounting structures 102, each bent end may include a drive unit mount 112. In this way, the drive unit mount 112 may be located on the bend end 105, and thus on the distal end of the arms 104.

In embodiments, the mounting structures 102 include one or more chassis mounts 114. The chassis mounts 114 may be configured to couple the mounting structures 102 to a chassis of a vehicle.

The chassis mounts 114 may be configured as blind holes. In this way, the chassis mounts 114 may be used to couple the mounting structures to the vehicle chassis. Additionally, the chassis mounts 114 may be threaded.

The chassis mounts 114 may be located on the common body 106. In this way, the chassis mounts 114 may be in a relatively robust area of the mounting structures 102. Therefore, it may be desirable for torque to be directed to the chassis mounts 114.

Additionally, the mounting structures 102 may be designed in such a way that torque generated by wet brakes during braking may be directed away from the drive unit mounts 112 and towards the chassis mounts 114. In this way, the torque may be transferred to the chassis of the vehicle instead of to a drive unit. This may be beneficial, as the vehicle chassis may be better suited to absorb torque than the drive unit.

In embodiments, the mounting structures 102 may include one or more pass throughs 116. The pass throughs 116 may be any gaps in the material of the mounting structures 102 defined to allow access to other features of the mounting structures 102.

The pass throughs 116 may be located on any component of the mounting structures 102. For example, the pass throughs 116 may be located on an arm 104 of the mounting structures 102. By way of another example, the pass throughs 116 may be located on a flange 108 of the mounting structures 102.

The pass throughs 116 may be configured to provide access to at least one of the wet brake mounts 110 or at least one of the drive unit mounts 112. For example, tools and/or coupling components (e.g., bolts or screws) may have to utilize the pass throughs 116 to be able to couple the mounting structures 102 to wet brakes and/or a drive unit.

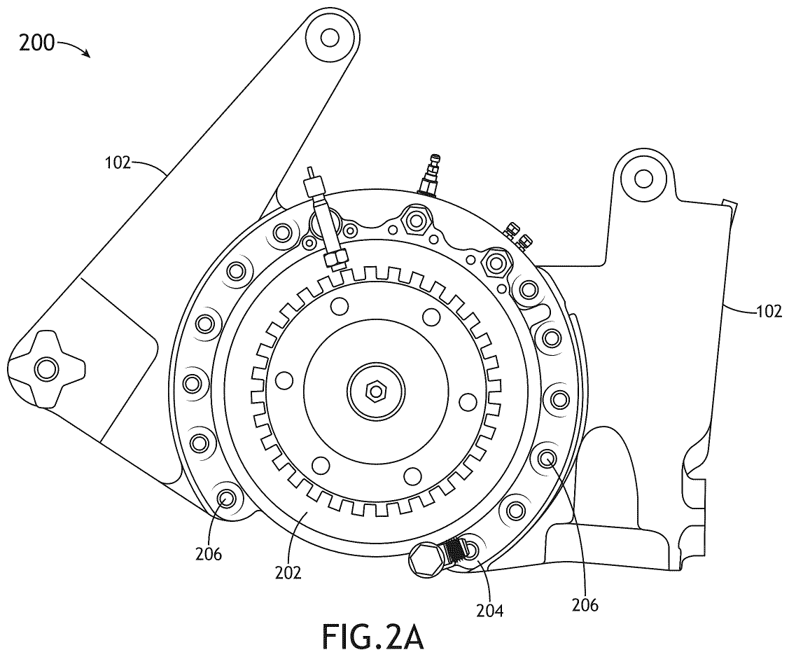

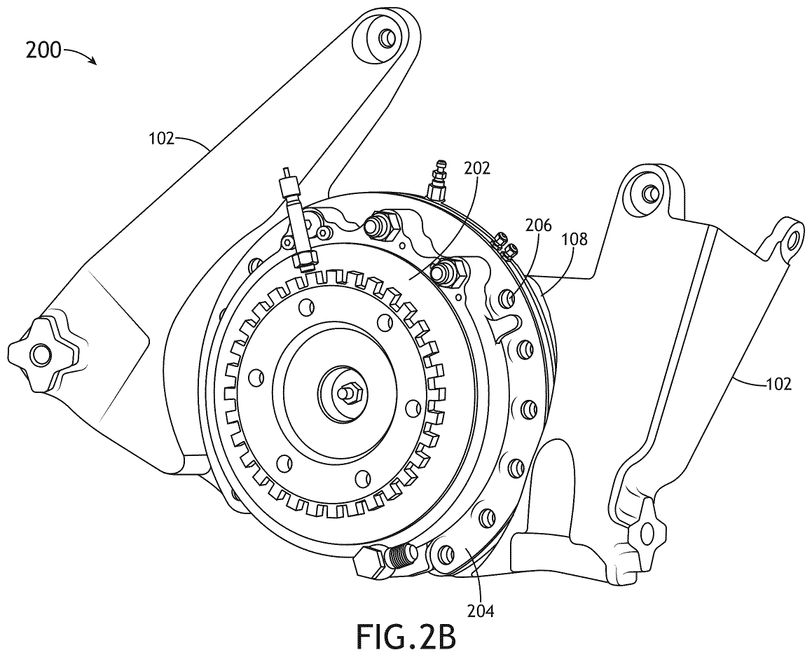

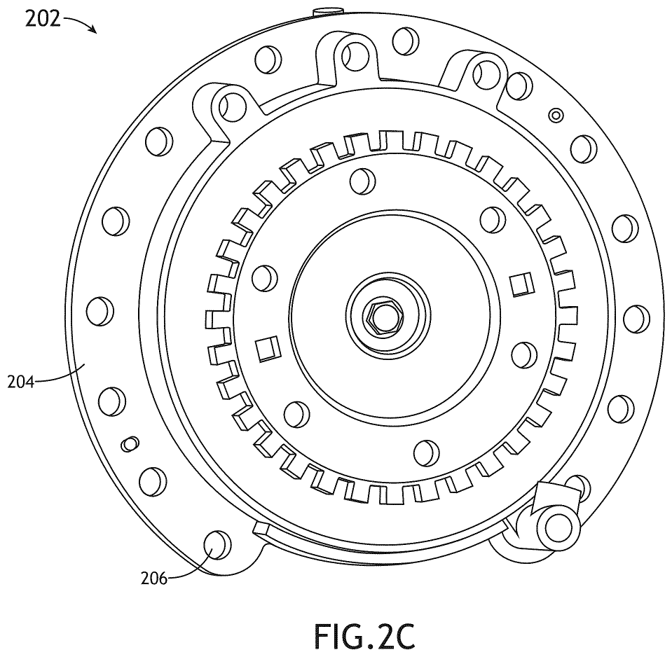

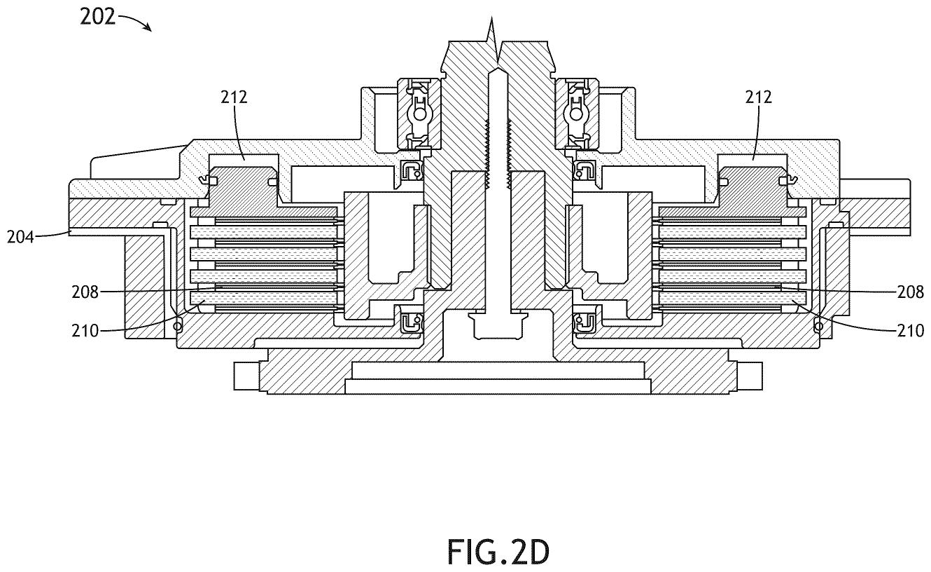

FIGS. 2A and 2B depict a wet brake assembly 200, in accordance with one or more embodiments of the present disclosure. In embodiments, the wet brake assembly 200 includes a wet brake 202. The wet brake 202 will be discussed in further detail with reference to FIGS. 2C and 2D.

In embodiments, the wet brake 202 may include one or more wet brake flanges 204. The wet brake flanges 204 may be located on the outer edge of the wet brake 202. The wet brake flanges 204 may be made from a single, flat piece of material or may be formed from several pieces of material compressed together.

The one or more wet brake flanges 204 may be configured as a single wet brake flange 204. In this way, the wet brake flange 204 may encircle the wet brake 202. However, the one or more wet brake flanges 204 may also be configured as multiple wet brake flanges 204 spaced about the perimeter of the wet brake 202. In this way, a weight of the wet brake 202 may be reduced, and the wet brake flanges 204 may be located only in areas where the wet brake flanges 204 overlap with the flanges 108.

In embodiments, the wet brake 202 may include one or more wet brake flange mounts 206. The wet brake flange mounts 206 may be located on the wet brake flange 204. For example, the wet brake flange mounts 206 may be circumferentially spaced about the wet brake flange 204 at even intervals or at uneven intervals. For example, the wet brake flange mounts 206 may be circumferentially spaced about the wet brake flanges 204 such that at least one of the wet brake flange mounts 206 aligns with at least one of wet brake mounts 110.

For example, the flanges 108 of the mounting system 100 and the wet brake flanges 204 of the wet brake 202 may be configured to align such that the mounting system 100 and the wet brake 202 may be coupled by the wet brake mounts 110 and the wet brake flange mounts 206.

Further, it is contemplated that the wet brake flange mounts 206 may be configured as through holes such that a fastener may pass through the wet brake flange mounts 206 and reach the wet brake mounts 110. Additionally, the wet brake flange mounts 206 may be threaded. The fastener may clamp together the wet brake flanges 204 and the flanges 108.

FIGS. 2C and 2D depict a wet brake 202, in accordance with one or more embodiments of the present disclosure.

In embodiments, the wet brake 202 may include one or more rotating discs 208. The rotating discs 208 may rotate as the vehicle moves and correspond to the movement of the vehicle (e.g., speed and direction).

In embodiments, the wet brake 202 may include one or more static discs 210. The static discs 210 may be static and dispersed between the rotating discs. During braking, the static discs 210 may come into contact with the rotating discs 208, causing the vehicle to decelerate and eventually stop.

In embodiments, the wet brake 202 may include a fluid 212. The fluid may be any fluid capable of preventing wear to the static discs 210 and the rotating discs 208. For example, the fluid 212 may be an oil.

The wet brake 202 may be a completely sealed system. In this way, the fluid 212 may be trapped within the wet brake 202. Additionally, outside contaminants (e.g., dust, dirt, road contaminants, or the like) may be prevented from penetrating the wet brake 202. Therefore, the lifespan of the wet brake 202 may be significantly improved and last for the lifespan of the vehicle.

Further, it is contemplated that during braking events the wet brake 202 may generate a torque. The mounting system 100 (e.g., the mounting structures 102 of the mounting system 100) may be designed to direct the torque away from the drive unit mounts 112 and towards the chassis mounts 114. This may be beneficial as the chassis mounts 114 may be more robust than the drive unit mounts 112 and/or may be coupled to a more robust part of the vehicle (e.g., the chassis).

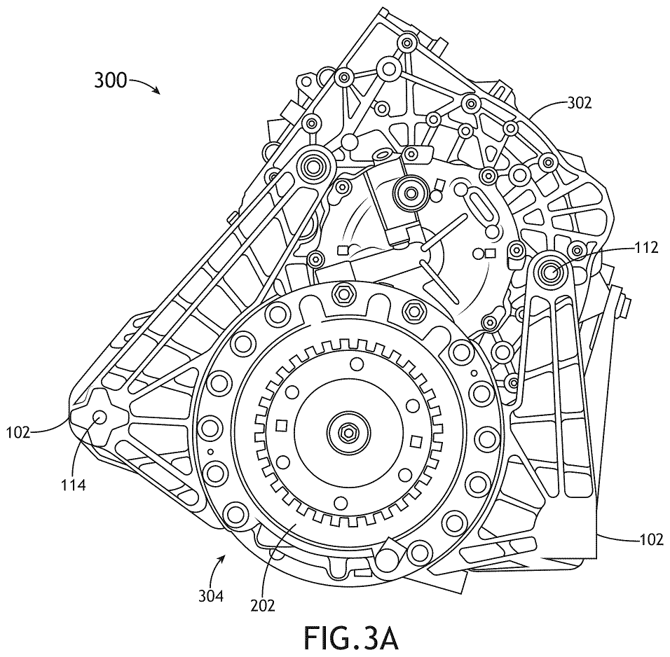

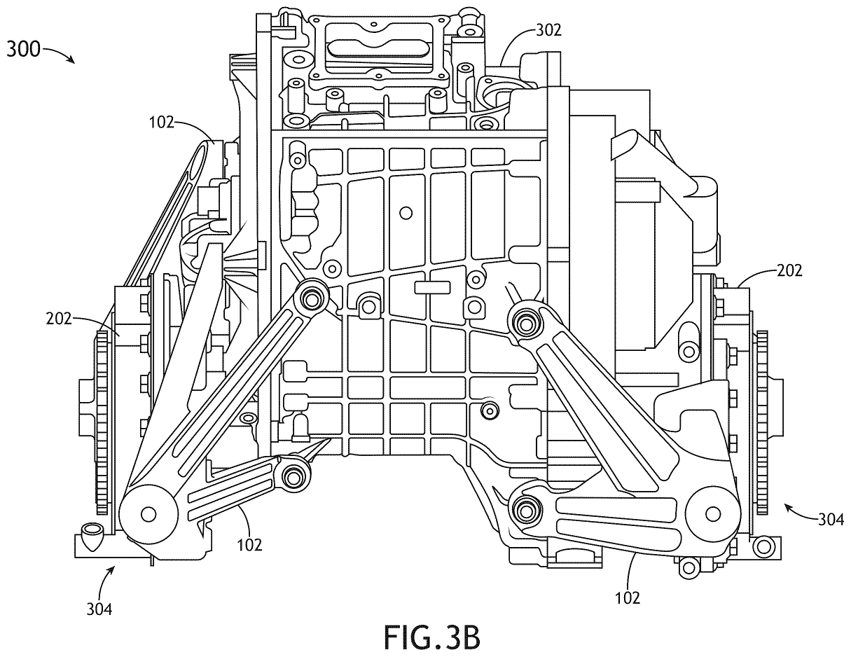

FIGS. 3A and 3B depict a drive assembly 300, in accordance with one or more embodiments of the present disclosure.

In embodiments, the drive assembly 300 includes a drive unit 302 and/or the wet brake assembly 200. The wet brake assembly 200 may be coupled to the drive unit 302. For example, the drive unit mounts 112 may couple the wet brake assembly 200 to the drive unit 302. The position and orientation of the drive unit mounts 112 may be based on corresponding mounting locations to which the drive unit mounts 112 couple on the drive unit 302. The drive unit 302 may be any drive unit known in the art. For example, the drive unit 302 may be an electric vehicle drive unit.

The drive unit 302 may include an output 304 on either side of the drive unit 302. For example, the output 304 may be designed to deliver torque generated by the drive unit 302 to the wheels of a vehicle via an axle. Therefore, the wet brake 202 may be positioned at the output 304 in order to stop the vehicle.

It is noted that the wet brake 202 may be positioned at either output 304 of the drive unit 302 with the mounting system 100. However, the wet brake 202 may be positioned at both outputs of the drive unit 302 with the mounting system 100.

Additionally, the mounting system 100 may be configured in such a way where wet brakes 202 may be added to a vehicle that was manufactured with a different type of brakes. In this way, vehicles may be retrofit for wet brake operations with use of the mounting system 100.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 mounting system
102 mounting structures
102a first mounting structure
102b second mounting structure
104 arms
105 bent end
106 common body
108 flanges
110 wet brake mounts
112 drive unit mounts
114 chassis mounts
116 pass throughs
200 wet brake assembly
202 wet brake
204 wet brake flanges
206 wet brake flange mounts
208 rotating discs
210 static discs
212 fluid
300 drive assembly
302 drive unit
304 output

What is claimed:

1. A mounting system comprising:
one or more mounting structures, each of the one or more mounting structures comprising:
one or more arms, wherein each of the one or more arms radiate from a common body;
one or more flanges, wherein each of the one or more flanges are integrated into one of the one or more arms, wherein each of the one or more flanges comprises one or more wet brake mounts;
one or more drive unit mounts, wherein each of the one or more arms includes one of the one or more drive unit mounts, wherein each of the one or more drive unit mounts are located on a distal end of a corresponding one or more arms; and
one or more chassis mounts, wherein the one or more chassis mounts are located on the common body.

2. The mounting system of claim 1, wherein the one or more mounting structures are configured as two separate mounting structures.

3. The mounting system of claim 2, wherein the two separate mounting structures are not mirror images of each other.

4. The mounting system of claim 1, wherein the one or more mounting structures are configured as a single, integrated mounting structure.

5. The mounting system of claim 1, wherein at least one of the one or more drive unit mounts is countersunk or counterbored into the corresponding arm.

6. The mounting system of claim 1, wherein the one or more chassis mounts are blind holes.

7. The mounting system of claim 1, wherein the one or more drive unit mounts and the one or more wet brake mounts are through holes.

8. The mounting system of claim 1, wherein the one or more arms comprise:
a bent end located on the distal end of the one or more arms, wherein the bent end includes one of the one or more drive unit mounts.

9. The mounting system of claim 1, wherein the mounting system further comprises:
a bent end, wherein the bent end extends from the one or more flanges, wherein the one or more flanges is disposed between the common body and the bent ends.

10. The mounting system of claim 1, wherein the one or more mounting structures further comprise:
one or more pass throughs, wherein the one or more pass throughs are configured to provide access to the at least one of the one or more wet brake mounts or at least one of the one or more drive unit mounts.

11. A wet brake assembly comprising:
a mounting system, wherein the mounting system comprises:
one or more mounting structures, each of the one or more mounting structures comprising:
one or more arms, wherein each of the one or more arms radiate from a common body;
one or more flanges, wherein each of the one or more flanges are integrated into one of the one or more arms, wherein each of the one or more flanges comprises one or more wet brake mounts;
one or more drive unit mounts, wherein each of the one or more arms includes one of the one or more drive unit mounts, wherein each of the one or more drive unit mounts are located on a distal end of a corresponding one or more arms; and
one or more chassis mounts, wherein the one or more chassis mounts are located on the common body; and
a wet brake, wherein the wet brake comprises:
one or more wet brake flanges, wherein the one or more wet brake flanges comprise:
one or more wet brake flange mounts, wherein the one or more flanges of the mounting system and the one or more wet brake flanges of the wet brake are aligned such that the mounting system and the wet brake are coupled by the one or more wet brake mounts and the one or more wet brake flange mounts.

12. The wet brake assembly of claim 11, wherein the one or more wet brake flange mounts are through holes.

13. The wet brake assembly of claim 11, wherein the one or more wet brake flange mounts are spaced about the one or more wet brake flanges such that at least one of the one or more wet brake flange mounts aligns with at least one of the one or more wet brake mounts.

14. The wet brake assembly of claim 11, wherein the one or more wet brake flanges is configured as a single wet brake flange that encircles the wet brake.

15. A drive assembly comprising:
a mounting system, wherein the mounting system comprises:
one or more mounting structures, each of the one or more mounting structures comprising:
one or more arms, wherein each of the one or more arms radiate from a common body;
one or more flanges, wherein each of the one or more flanges are integrated into one of the one or more arms, wherein each of the one or more flanges comprises one or more wet brake mounts;
one or more drive unit mounts, wherein each of the one or more arms includes one of the one or more drive unit mounts, wherein each of the one or more drive unit mounts are located on a distal end of a corresponding one or more arms; and
one or more chassis mounts, wherein the one or more chassis mounts are located on the common body;
a wet brake, wherein the wet brake comprises:
one or more wet brake flanges, wherein the one or more wet brake flanges comprise:
one or more wet brake flange mounts, wherein the one or more flanges of the mounting system and the one or more wet brake flanges of the wet brake are configured to align such that the mounting system and the wet brake may be coupled by the one or more wet brake mounts and the one or more wet brake flange mounts; and
a drive unit, wherein the mounting system is coupled to the drive unit by the one or more drive unit mounts, wherein a torque generated by the wet brake is directed to the one or more chassis mounts and away from the one or more drive unit mounts.

16. The drive assembly of claim 15, wherein the drive unit is an electric vehicle drive unit.

17. The drive assembly of claim 15, wherein the drive unit comprises:
an output on either side of the drive unit.

18. The drive assembly of claim 17, wherein the wet brake is located at an output on one side of the drive unit with the mounting system.

19. The drive assembly of claim 17, wherein the wet brake is located at an output on both sides of the drive unit with the mounting system.

20. The drive assembly of claim 15, wherein a position and an orientation of the one or more drive unit mounts is based on corresponding mounting locations to which the one or more drive unit mounts couple to the drive unit.
